(19) United States
(12) Patent Application Publication
(10) Pub. No.: US 2007/0047439 A1
(43) Pub. Date: Mar. 1, 2007

(54) Method and apparatus of supporting business performance management with active shared data spaces

(76) Inventors: Lianjun An, Yorktown Heights, NY (US); Hung-Yang Chang, Scarsdale, NY (US); Shyh-Kwei Chen, Chappaqua, NY (US); Pawan Raghunath Chowdhary, Montrose, NY (US); Michael John Dikun, Wantagh, NY (US); Jun-Jang Jeng, Armonk, NY (US); Josef Schiefer, Vienna (AT)

Correspondence Address: Whitham, Curtis, & Christofferson, P.C., Suite 340, 11491 Sunset Hills Road, Reston, VA, 20190, US

(21) Appl. No.: 11/211,740

(22) Filed: Aug. 26, 2005

(51) Int. Cl. H04L 12/26

(52) U.S. Cl. 370/231

(57) ABSTRACT

A managed policy driven virtual data space for managing artifacts relationships and sharing artifacts among services. A policy model is used to represent business artifacts, sharing of the artifacts, and subscription of other artifacts that is of interest to current artifact and, to represent the various state of the artifact. An active shared space provides support functionality for the policy model, such as artifact lifecycle management. The active shared space also provides the support of sharing of such artifact with external/internal services and other artifacts. The active shared space also controls the artifacts storage in the relational database for archiving purposes. Active shared space also provides the mechanism of subscribing to various artifacts and publishing the availability of artifact for services and other artifacts itself. Active shared space also makes the artifact aware of the context within which the said artifact operates and allows subscribing to appropriate artifacts to support the context needs. Active shared space also provides the mechanism to trace through the various states of an artifact and facility to query the artifact data content.

### BACKGROUND OF THE INVENTION

1. Field of the Invention

The present invention generally relates to Business Performance Management (BPM) implemented in software on a computer system and, more particularly, to a managed policy driven virtual data space for managing artifacts relationships and sharing artifacts among services.

2. Background Description

In today's world, Businesses are integrating their processes to achieve efficiencies and drive value. Although such integration results in many services brought together, sharing the resources, both business and IT, among the services is still a big challenge. Additionally monitoring of the processes has become very important as any interruption in the functioning of these processes and services can have catastrophic impact in the bottom line of the businesses. Secondly, the tool, such as BPM (Business Performance Monitoring), that enables the ability to monitor and analyze operational, organizational, and strategic KPIs (Key Performance Indicator) has become indispensable to effectively compete in the market place.

With BPM gaining larger acceptance, the enterprise the monitoring system have started to see manifold increase in the volume of business data and hence putting considerable strain on the existing middleware and services infrastructure, there by rendering them inefficient. Such inefficiencies can limit the benefits of process integration and real time KPI visibility there by diminishing the return on investments and effectiveness of the monitoring tools. Such problem can increase multifold as more processes are integrated and monitoring requirement of these processes increases. Today's middleware are still evolving and not sophisticated enough to provide efficient solution to the growing problem and necessary features as mentioned below:
Event Distribution,
Event/Data Artifacts life cycle management,
Access Control to Business Artifacts,
Sharing of Business artifacts,
Pre-compute (Aggregation, etc) analytics for Business artifacts, etc., and
Models to define and manage the event/business artifacts, define sharing of artifacts with Services and Access Control to the artifacts.

Current Business Performance Management (BPM) solution services take the business artifacts as input and generate other business artifacts such as situations, decisions, actions, and the like. The typical BPM solution might pass all the business artifacts to the services as they become available for the processing even though services are not required to process them immediately or services need other artifacts to become available.

The services use messaging or other infrastructure to communicate business artifacts among each other. The large flow of business artifacts puts constraints on the infrastructure and lets through considerable unnecessary transaction data with the result that the underlying infrastructure may not perform up to a desired optimum level.

The other challenge comes from integration. There are many legacy systems available in the enterprise. Some comes from different venders and some are home-developed. When coming to create business solution based on their business operation, each component only processes some part of business artifacts related to the operation. It is difficult to exam the business process as a whole from data representation standpoint. All artifacts are stored in their distributed, heterogeneous way in multiple components.

The current BPM solutions service also lacks a meta model that could police the flow of data content to various BPM services. And due to the distributed nature of BPM solutions, there is often a lack of visibility into processing the state of services and business artifacts. Existing shared spaces provide cache to temporarily store information, but they are not active in nature nor are aware of semantics/nature of the date. The external services interacting with the shared space controls the data.

### SUMMARY OF THE INVENTION

It is therefore an object of the present invention to provide a method and apparatus to enable business artifacts sharing among multiple components, to provide a platform to deploy governing model for individual business process, and to provide visibility of on-going business process instances.

According to the present invention, Active Shared Space Server is provided as part of the solution and its features are summarized below:
Active Shared Space Server, as artifact data container of business process instance, is a managed and policy driven virtual data space for sharing BPM artifacts among services for processing BPM artifacts such as events, metrics, situations, decisions, actions and other. associated business records representing its business operation.
Active Shared Space Server is a central controller component which coordinates the communication between services. The artifact dependency of a business process is governed by a policy model.
Active Shared Space Server regulates the flow of information (BPM artifacts) during the BPM runtime to various services. It provides the necessary filter to let the meaningful business data come into the system based on its policy model.
BPM context, which consists of artifacts of a business process instance, correlates the data from different services and recognize the stage of artifact processing and detect business situation. Active Shared Space Server notifies relevant services only when it senses that necessary data has been collected based on their subscription and services can act upon them meaningfully. This approach eases the processing requirement on functional services and let them act upon actual required data, thereby improving performance and throughput significantly.
A Meta model actively manages the BPM context scope and life cycle of artifacts. Active Shared Space Server provides virtual data space for running business process instances as well as finished business process instances.
Active Shared Space Server provides access to data in a data warehouse or OLAP (On-Line Analytical Processing) databases seamlessly based on the deployed model information.
Active Shared Space Server provides subscription services which allow components to register its interest in BPM artifacts. Based on the subscriptions, Active Shared Space Server automatically delivers the BPM artifacts to the listening components. Such event driven approach enables real time interaction among components.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of a computer system on which the method according to the invention may be implemented;

FIG. 2 is a block diagram of a server used in the computer system shown in FIG. 1;

FIG. 3 is a block diagram of a client used in the computer system shown in FIG. 1;

FIG. 4 is a block and dataflow diagram showing a conventional system to cache or share data;

FIG. 5 is a high level flow diagram showing the active shared space solution according to the present invention;

FIG. 6 is a block diagram showing in more detail required components that support functionalities of the active shared space;

FIG. 7 is a block diagram showing how the space manages living artifact to represent the current stage of a business process instance; and

FIG. 8 is a block diagram showing the deploying process of enterprise solution that uses the active shared space.

### DETAILED DESCRIPTION OF A PREFERRED EMBODIMENT OF THE INVENTION

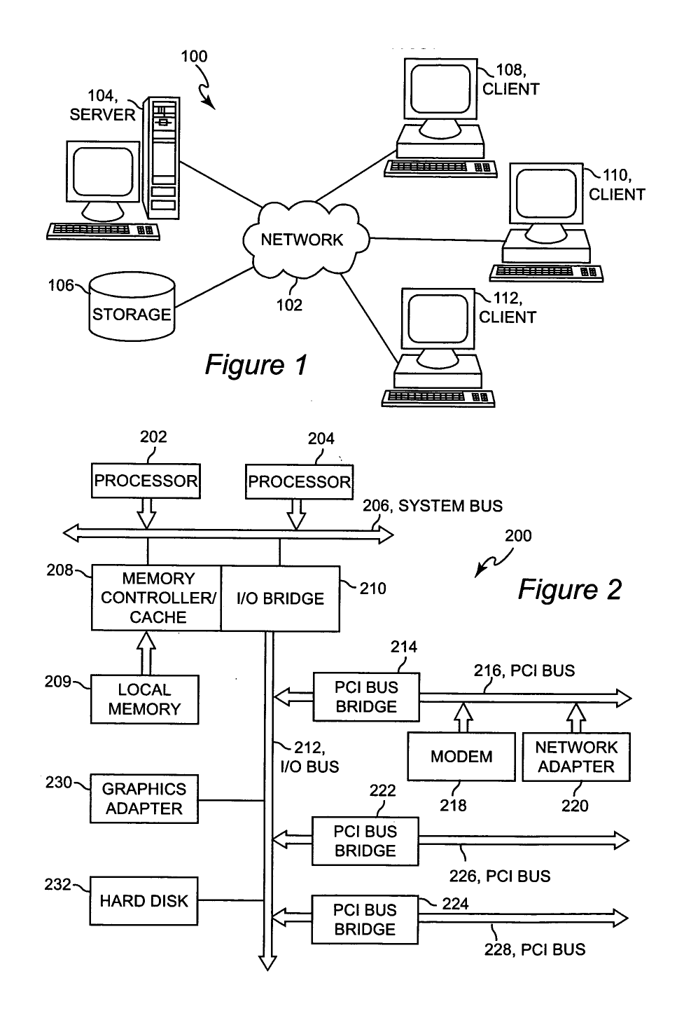

Referring now to the drawings, and more particularly to FIG. 1, there is shown a computer system on which the method according to the invention may be implemented. Computer system 100 contains a network 102, which is the medium used to provide communications links between various devices and computers connected together within computer system 100. Network 102 may include permanent connections, such as wire or fiber optic cables, wireless connections, such as wireless Local Area Network (WLAN) products based on the IEEE 802.11 specification (also known as Wi-Fi), and/or temporary connections made through telephone, cable or satellite connections, and may include a Wide Area Network (WAN) and/or a global network, such as the Internet. A server 104 is connected to network 102 along with storage unit 106. In addition, clients 108, 110 and 112 also are connected to network 102. These clients 108, 110 and 112 may be, for example, personal computers or network computers. For purposes of this application, a network computer is any computer, coupled to a network, which receives a program or other application from another computer coupled to the network. The server 104 provides data, such as boot files, operating system images, and applications to clients 108, 110 and 112. Clients 108, 110 and 112 are clients to server 104.

Computer system 100 may include additional servers, clients, and other devices not shown. In the depicted example, the Internet provides the network 102 connection to a worldwide collection of networks and gateways that use the TCP/IP (Transmission Control Protocol/Internet Protocol) suite of protocols to communicate with one another. At the heart of the Internet is a backbone of high-speed data communication lines between major nodesior host computers, consisting of thousands of commercial, government, educational and other computer systems that route data and messages. In this type of network, hypertext mark-up language (HTML) documents and applets are used to exchange information and facilitate commercial transactions. Hypertext transfer protocol (HTTP) is the protocol used in these examples to send data between different data processing systems. Of course, computer system 100 also may be implemented as a number of different types of networks such as, for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Server 200 may be used to execute any of a variety of business processes. Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. Input/Output (I/O) bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

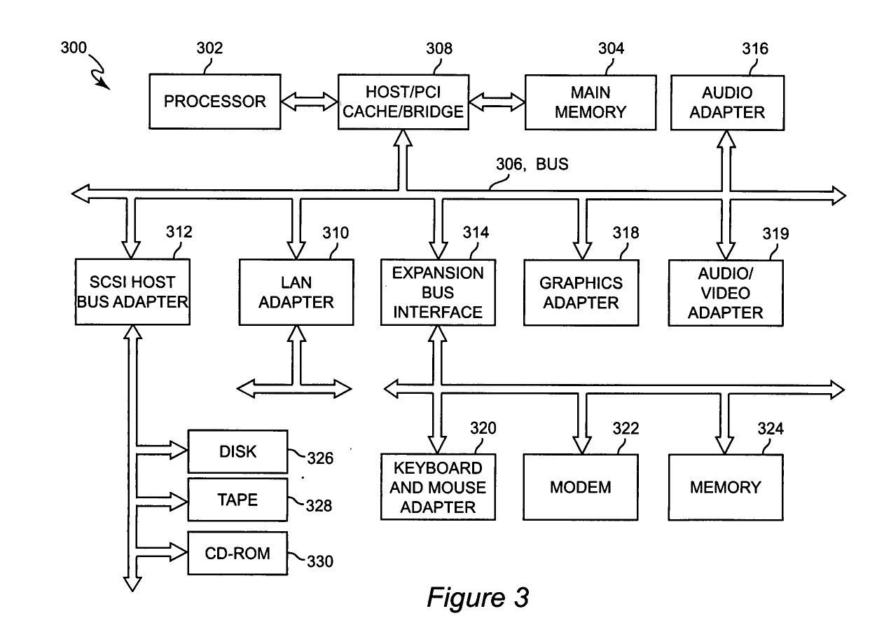

With reference now to FIG. 3, a block diagram illustrating a client computer is depicted in accordance with a preferred embodiment of the present invention. Client computer 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, Small Computer System Interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, and/or I/O devices, such as Universal Serial Bus (USB) and IEEE 1394 devices, may be used in addition to or in place of the hardware depicted in FIG. 3. Also, the processes of the present invention may be applied to a multiprocessor data processing system.

Data processing system 300 may take various forms, such as a stand alone computer or a networked computer. The depicted example in FIG. 3 and above-described examples are not meant to imply architectural limitations.

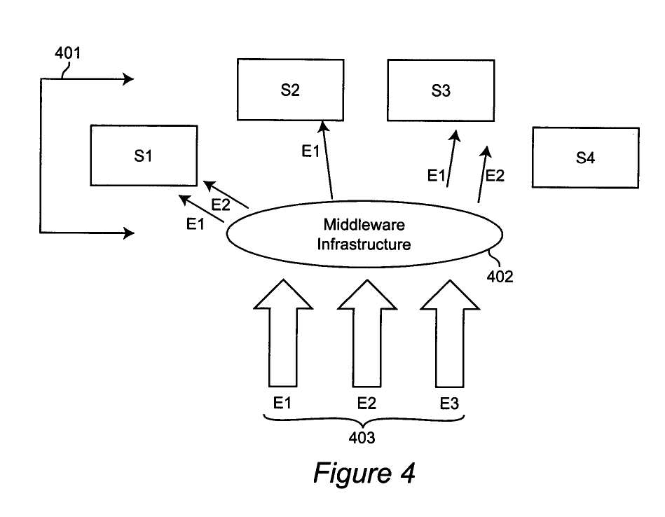

In order to better understand the invention, consider a very simple example which illustrates how an existing BPM solution might handle the events coming into the system and gets distributed to the various services that are part of the solution. The FIG. 4 illustrates a simple example of one aspect of the problem in discussion (event distribution). Events 403 are distributed to the services via middleware infrastructure 402. As the events become available, they are sent to services 401 via subscription or services polling for the events. Suppose that services S1 and S3 need events E1 and E2 to complete a task. As the services 401 receive an event 403, it may start the processing of task but it might have to wait for another event to complete the task there by keeping the processes running. All the running processes utilize the system resources and, as volume of events increases, the resource utilization starts to go up and starts to drag the system, thereby effecting the efficiencies of the services.

Additionally, there is a potential remote call or transaction for each event 403 sent to services there by increasing the utilization of network bandwidth and higher traffic flow. Moreover, from the control point of view a middleware 402 might not be capable of managing event access for each service; hence a service could potentially subscribe to all the events and filter at their end there by increasing the load on to the infrastructure.

Services could also potentially publish an event as part of its processing and the current middleware might not be able to establish the relationship between the event inputs and outputs. Additionally, various services might wish to subscribe to these output events from other services and the middleware might be limited to provide such functionality. Moreover, from the event tracing purposes, one might need to manage the life cycle of the events and its relationship with other events.

Active Shared Space is a pluggable component that enhances the functionality of existing middleware and attempts to provide solution to the sets of problems as mentioned above. It is a policy driven virtual shared space that permits services component to register for the artifacts of interest and publish the resultant artifacts into the shared space. The framework provides functionality such as correlation, notification to appropriate services about the availability of artifacts, build relationship between artifacts and provide persistent storage for the artifacts for the later retrieval. The framework also maintains the state of the data artifacts and also lets services to publish its internal state. This could provide visibility into the processing state of the services. It can also provide additional functionality such as accessing external data store, multidimensional data stores, etc. The details for the architecture and framework components according to a preferred embodiment of the invention are described below.

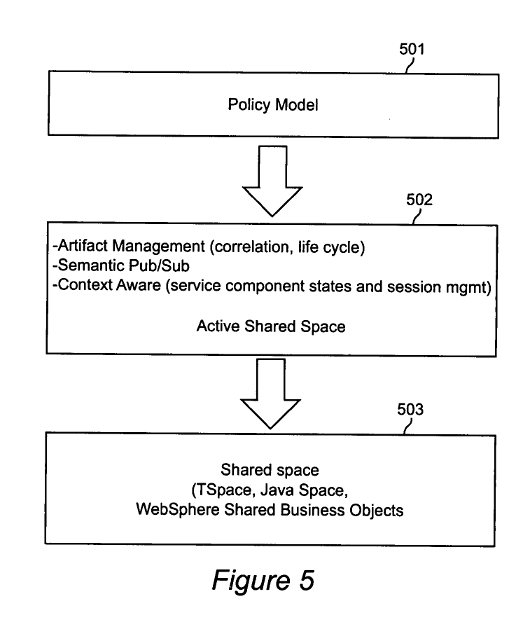

With reference now to FIG. 5, the block diagram illustrates the major differences 501, 502 that the present invention provides on top of the existing 503 prior art, as described with respect to FIG. 4. Policy model 501 is used to represent business artifacts, sharing of the artifacts, and subscription of other artifacts that is of interest to current artifact and, to represent the various state of the artifact. Active shared space 502 provides support functionality for policy model 501 such as artifact lifecycle management, such as when an artifact gets created and archived. It also provides the support of sharing of such artifact with external/internal services and other artifacts. It also controls the artifacts storage in the relational database for archiving purposes. Active shared space 502 also provides the mechanism of subscribing to various artifacts and publishing the availability of artifact for services and other artifacts itself. Active shared space 502 also makes the artifact aware of the context within which the said artifact operate and allow subscribing to appropriate artifacts to support the context needs. Active shared space 502 also provides the mechanism to trace through the various states of an artifact and facility to query the artifact data content.

Shared space 503 (402 in FIG. 4) supports very primitive sharing of data but it is not aware of the artifact structure and does not manage the life cycle of the artifacts. The tuple space supports very primitive communication primitives such as “in”, “out” and “rd”. Similarly, Java space also supports limited operations like “write” to store an object in the space, “read” to access the object and “take” to retrieve the object from the space

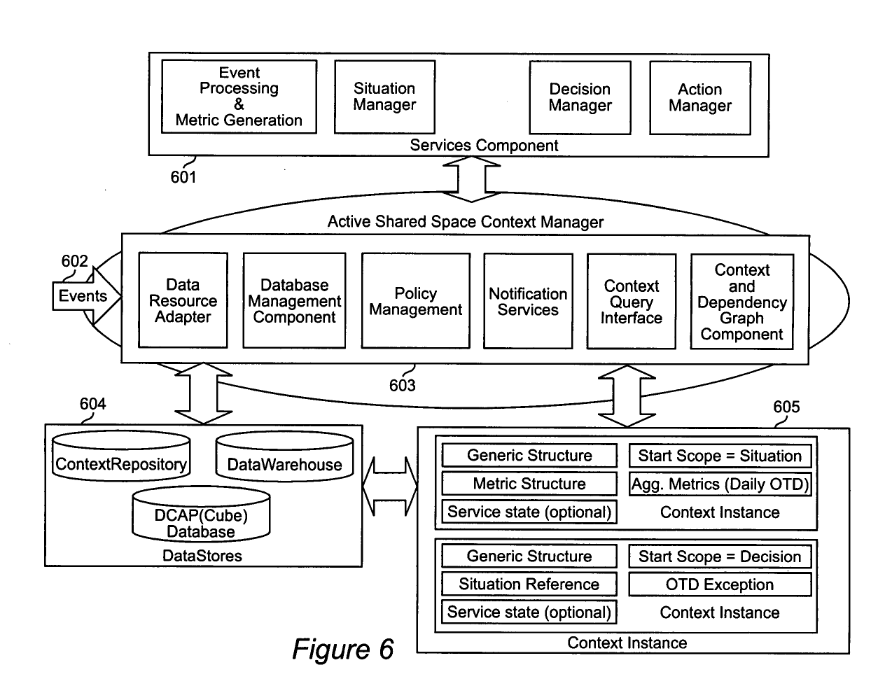

With reference to FIG. 6, the block diagram illustrates the Artifacts Life Cycle management, semantic pub/sub functionality as shown in active shared space 502 and the related support components. It also shows how the services 601 and artifacts 605 can subscribe to other artifacts. More particularly, active shared space context manager 603 includes components that help in managing the lifecycle of the artifacts. The Data Resource Adaptor is a software program to access the artifacts stored in data stores 604. This is a generic program that is used by all the components in active shared space context manager 603 and context instance 605 to access the database of records. The Database Management Component provides functionality to create database table structure for storing the artifacts. These two components help in archiving of the artifacts as mentioned in connection with active shared space 502 (FIG. 5). The Policy Management component is responsible for managing the policy about an artifact. It contains information about the artifacts lifecycle, its subscription, when it can be published to other services and artifacts, etc. The policy as such is a document expressed in XML (eXtensible Markup Language) that captures the artifacts information as mentioned previously. The Notification Services is responsible for making an artifact that is ready for sharing available by various means such as Messaging Middleware, Web Services, Remote Procedural Call (RPC), etc. The Context Query Interface component facilitates in accessing the content of a context instance by providing easy to use query mechanism. The Context and Dependency Graph component manages the artifacts dependencies upon one another.

Events 602 define an optional event artifact that gets the data from outside system into the current defined system. The data carried by the event could lead to the initiation of the artifact by policy management component in conjunction with context and dependency graph component. It could also provide the artifacts information to other artifacts that are interested in such information. The active shared space context manager 603 helps in reading events 602, archive events 602 and distribute the artifact carried by events 602 accordingly.

Data stores 604 define the relational database of records where the artifacts are archived. The system also stores all the context and dependency graph such that the artifact path could be retraced.

Context instance 605 define an instance of an artifact (context instance). The artifact gets instantiated when appropriate stimulus arrives (via events 602, for example). Depending upon the policy it could be very short lived artifact ( instance creation, available for share and destroyed) or could be long lived ( subscribe to other artifacts, recalculate itself, publish itself, and so on).

Services component 601 includes potential services that might be interested in the artifacts for the processing purposes and could re send the artifacts as a response to notification services or as an event artifact 602.

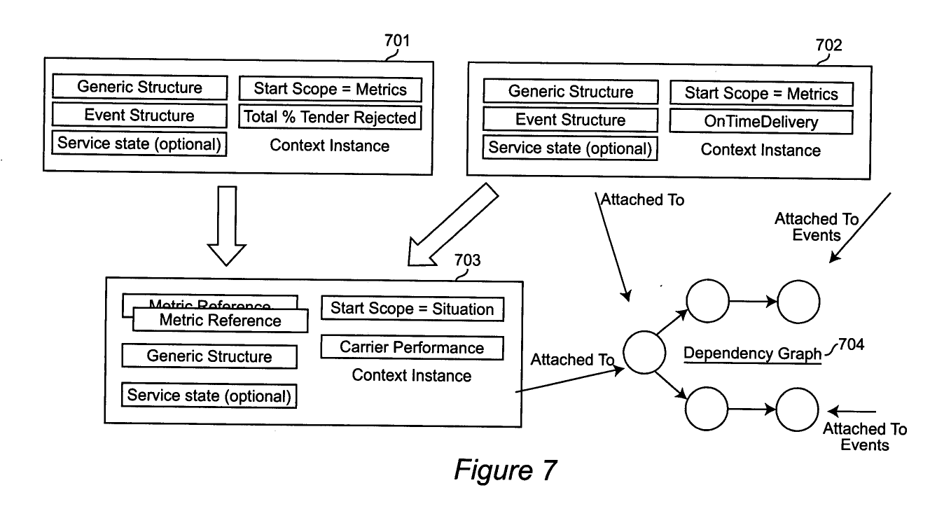

With reference to FIG. 7, the block diagram illustrates the Context and Artifact dependency graph that is part of active shared space 502 (FIG. 5) functionality. Context instance 701 and context instance 702 illustrate instances of artifacts (context instance) that is the same as context instance 605 (FIG. 6). Context instance 703 illustrates another artifact instance but also shows that it subscribes to both context instances 701 and 702. This subscription will be described in a policy model 501 (FIG. 5), active shared space context management 603 (FIG. 6). Dependency graph 704 illustrates the dependency graph for all artifact instances. There will be many dependency graphs for a particular application system. The dependency graph helps in the traceability of the artifacts, subscription points for the artifacts and mechanism for services to understand the type of content that an artifact contains. The dependency graph gets generated from the policy model and maintained by a related component in active shared space context management 603. Each node in the dependency graph 704 represents an artifact instance. Each dependency graph 704 and artifact instance 701, 702, and 703 depends upon distinct identity (for correlation purposes).

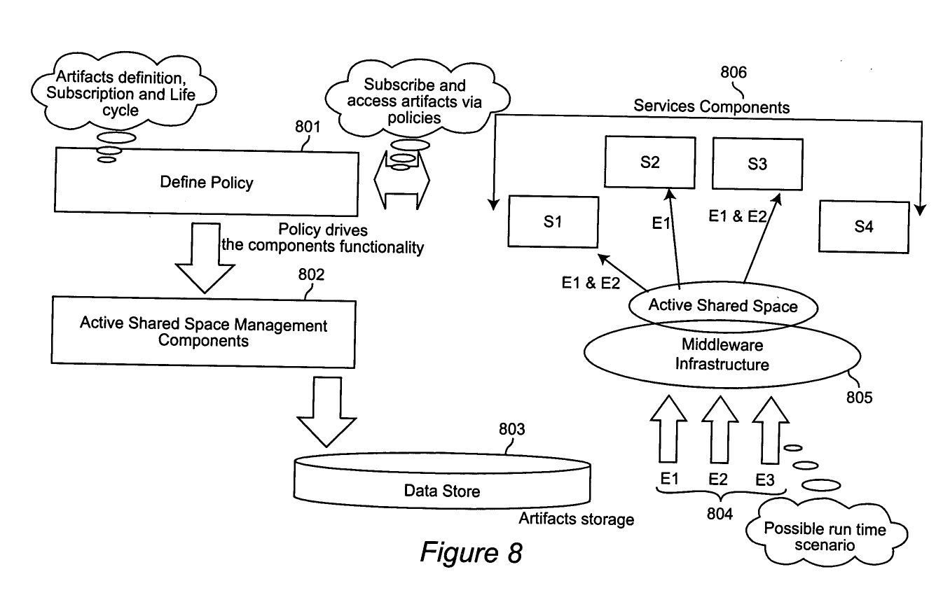

With reference to FIG. 8, there is illustratated the conceptual solution according to the invention, both at design time and at execution time. One begins with defining a policy 801 (501 in FIG. 5) for the artifacts, including the structure of the artifacts, life cycle, other artifacts subscription, its states of sharing, archiving and access control. The policy then feeds into the active shared space management components 802 (603 in FIG. 6) to generate the components that control the artifact at the execution time. Both the define policy 801 procedure and the active shared space management components 802 are part of design time activity.

Data store 803 is part of both design time and execution time component. At the design time it stores the policy and other components configuration such as dependency graph definitions, access policy, artifact definition, etc.

Service components 806 form part of external service that subscribes to the artifacts. These services has to listed in the policy (either at design time or at execution time) to become eligible for the subscription of artifact. Middleware infrastructure 805 represents the execution time view of the active shared space component as a whole. It takes the multiple events 804 as input and initializes an artifact instance or assigns it to subscribing artifacts. An artifact as per the policy would wait for more artifacts or for a time to reach to a certain state. Once it reaches a desired state it would make itself available for subscription. Other artifacts as per their subscription request could acquire this artifact (as per the dependency graph) and subsequently makes itself available for subscription as soon as it reaches a desire state. This way the subscribing services will only get to know of an artifact once it reaches a state and there by not get overwhelmed by the artifacts. The Active Shared Space of the middleware infrastructure 805 manages the life cycle of the artifacts and archives the artifacts once it reaches the final state. The dependency graph for an instance of an artifact is also archived. This enables the auditing of the artifacts for any historical analysis purposes. The Active Shared Space of the middleware infrastructure 805 also forms the central controller component that controls the flow of the artifacts among services and there by preventing the system from getting overwhelmed with the incoming data. Various functions could be performed by the artifacts by defining those in the policy file such as aggregation of artifacts, time variant sharing of the artifacts, etc. Additionally, data store 803 could be expanded to create OLAP (On-Line Analytical Processing) aware data warehouse for the business intelligence purposes.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A system for sharing data artifacts among services, comprising:
means for managing and optimizing data to govern data and information flow among services;
means for employing a common policy to govern data and information flow; and
means for managing relationship and traceability between artifacts.

2. The system of claim 1, wherein the artifacts include events, metrics, situations, decisions, actions, and associated data.

3. The system of claim 1, wherein the artifacts are stored in shared object space and database.

4. The system of claim 1, further comprising a central controller coordinating communication and collaboration of data artifacts among services and components.

5. The system of claim 1, further comprising a central controller controlling access to Business Performance Management (BPM) artifacts.

6. The system of claim 1, wherein data sharing processes and corresponding actions are governed by policies.

7. The system of claim 1, wherein active shared space scope, virtual data space, and life cycle of artifacts are actively managed by policies.

8. The system of claim 1, wherein policy driven correlation, filtering, and aggregation are employed as enablers to improve system performance throughput.

9. A method for sharing data artifacts among services, comprising the steps of:
managing and optimizing data to govern data and information flow among services;
employing a common policy to govern data and information flow; and
managing relationship and traceability between artifacts.

10. The method of claim 9, wherein the artifacts include events, metrics, situations, decisions, actions, and associated data.

11. The method of claim 9, further comprising the step of storing the artifacts in shared object space and database.

12. The method of claim 9, further comprising the step of centrally coordinating communication and collaboration of data artifacts among services and components.

13. The method of claim 9, further comprising the step of centrally controlling access to Business Performance Management (BPM) artifacts.

14. The method of claim 9, further comprising the steps of:
defining policies for artifacts including a structure of the artifacts, life cycle, other artifacts subscription, states of sharing, archiving and access control; and
governing data sharing processes and corresponding actions are governed by defined policies.

15. The method of claim 9, further comprising the steps of:
defining policies for artifacts; and
actively managing active shared space scope, virtual data space, and life cycle of artifacts by defined policies.

16. The method of claim 9, further comprising the steps of:
defining polices for artifacts; and
driving correlation, filtering, and aggregation by defined policies as enablers to improve system performance throughput.

17. A computer readable medium containing code implementing a method for sharing data artifacts among services, the method comprising the steps of:
managing and optimizing data to govern data and information flow among services;
employing a common policy to govern data and information flow; and
managing relationship and traceability between artifacts.

18. The computer readable medium of claim 17, where in the method implemented by the code further comprises the steps of:
defining policies for artifacts including a structure of the artifacts, life cycle, other artifacts subscription, states of sharing, archiving and access control; and
governing data sharing processes and corresponding actions are governed by defined policies.

19. The computer readable medium of claim 17, wherein the method implemented by the code further comprises the steps of:
defining policies for artifacts; and
actively managing active shared space scope, virtual data space, and life cycle of artifacts by defined policies.

20. The computer readable medium of claim 17, wherein the method implemented by the code further comprises the steps of:
defining polices for artifacts; and
driving correlation, filtering, and aggregation by defined policies as enablers to improve system performance throughput.
